(19) United States
(12) Patent Application Publication
(10) Pub. No.: US 2007/0257738 A1
(43) Pub. Date: Nov. 8, 2007

(54) Top metal layer shield for ultra-small resonant structures

(75) Inventor: Jonathan Gorrell, Gainesville, FL (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Virgin Islands Microsystems, Inc., St. Thomas, VI (US)

(21) Appl. No.: 11/418,097

(22) Filed: May 5, 2006

(51) Int. Cl. H01S 1/06

(52) U.S. Cl. 331/94.1

(57) ABSTRACT

When using micro-resonant structures which are being excited and caused to resonate by use of a charged particle beam, whether as emitters or receivers, especially in a chip or circuit board environment, it is important to prevent the charged particle beam from coupling to or affecting other structures or layers in the chip or circuit board. Shielding can be provided along the path of the charged particle beam, on top of the substrate, to prevent such coupling.

### CROSS-REFERENCE TO CO-PENDING APPLICATIONS

The present invention is related to the following co-pending U.S. patent applications: (1) U.S. patent application Ser. No. 11/238,991 [atty. docket 2549-0003], filed Sep. 30, 2005, entitled “Ultra-Small Resonating Charged Particle Beam Modulator”; (2) U.S. patent application Ser. No. 10/917,511 [atty. docket 2549-0002], filed on Aug. 13, 2004, entitled “Patterning Thin Metal Film by Dry Reactive Ion Etching”; (3) U.S. application Ser. No. 11/203,407 [atty. docket 2549-0040], filed on Aug. 15, 2005, entitled “Method Of Patterning Ultra-Small Structures”; (4) U.S. application Ser. No. 11/243,476 [Atty. Docket 2549-0058], filed on Oct. 5, 2005, entitled “Structures And Methods For Coupling Energy From An Electromagnetic Wave”; (5) U.S. application Ser. No. 11/243,477 [Atty. Docket 2549-0059], filed on Oct. 5, 2005, entitled “Electron beam induced resonance,”, (6) U.S. application Ser. No. 11/325,432 [Atty. Docket 2549-0021], entitled “Resonant Structure-Based Display,” filed on Jan. 5, 2006; (7) U.S. application Ser. No. 11/325,571 [Atty. Docket 2549-0063], entitled “Switching Micro-Resonant Structures By Modulating A Beam Of Charged Particles,” filed on Jan. 5, 2006; (8) U.S. application Ser. No. 11/325,534 [Atty. Docket 2549-0081], entitled “Switching Micro-Resonant Structures Using At Least One Director,” filed on Jan. 5, 2006; (9) U.S. application Ser. No. 11/350,812 [Atty. Docket 2549-0055], entitled “Conductive Polymers for the Electroplating”, filed on Feb. 10, 2006; (10) U.S. application Ser. No. 11/302,471 [Atty. Docket 2549-0056], entitled “Coupled Nano-Resonating Energy Emitting Structures,” filed on Dec. 14, 2005; (11) U.S. application Ser. No. 11/325,448 [Atty. Docket 2549-0060], entitled “Selectable Frequency Light Emitter”, filed on Jan. 5, 2006; and (12) U.S. application Ser. No. 11/400,280 [Atty. Docket 2549-0068], entitled “Resonant Deflector For Optical Signals”, filed on Apr. 10, 2006, which are all commonly owned with the present application, the entire contents of each of which are incorporated herein by reference.

### FIELD OF INVENTION

This relates to ultra-small, light or EMR emitting resonant structures when excited by a beam of charged particles, and more particularly to shielding the beam path to prevent or minimize any coupling of that beam with any other structures or layers in a chip or a circuit board environment.

### INTRODUCTION

In the above-identified patent applications, the design and construction methods for ultra-small structures for producing electromagnetic radiation, in a wide number of spectrums, are disclosed. Creating such results from micro-resonant structures requires them to be energized and excited by passing a charged particle beam past the micro-resonant structures. Such beams control when a resonant structure is turned on or off (e.g., when a display element is turned on or off in response to a changing image or when a communications switch is turned on or off to send data different data bits). In addition, rather than turning the charged particle beam on and off, the beam may be moved to a position that does not excite the resonant structure, thereby turning off the resonant structure without having to turn off the charged particle beam, and then the beam may be moved back to a position that does excite the resonant structure, thereby turning on that resonant structure.

In one such embodiment, at least one deflector can be placed between a source of charged particles and the resonant structure(s) to be excited to move the beam between a variety of positions. When the resonant structure is to be turned on (i.e., excited), the at least one deflector allows the beam to pass by the resonant structure undeflected. When the resonant structure is to be turned off, the at least one deflector deflects the beam away from the resonant structure by an amount sufficient to prevent the resonant structure from becoming excited.

In each of these situations, the charged particle beam will have a path of travel across the substrate on which the resonant structures have been formed, and toward, past and beyond the resonant structure(s) to be excited. It is along that path that grounded shielding can be provided to better control or eliminate the effects of the charged particle beam on other devices or portions of a chip or circuit board.

### BRIEF DESCRIPTION OF THE DRAWINGS

The following description, given with respect to the attached drawings, may be better understood with reference to the non-limiting examples of the drawings, wherein:

FIG. 1 is a generalized block diagram of a generalized resonant structure, its charged particle source and a shielded path for the charged particle beam;

FIG. 2 is a top view of another non-limiting exemplary resonant structure for use with the present invention and a shielded beam path;

FIG. 3 is a top view of a multi-wavelength element utilizing plural deflectors along various points in the path of the beam and a modified shielded path.

### DISCUSSION OF THE PREFERRED EMBODIMENTS

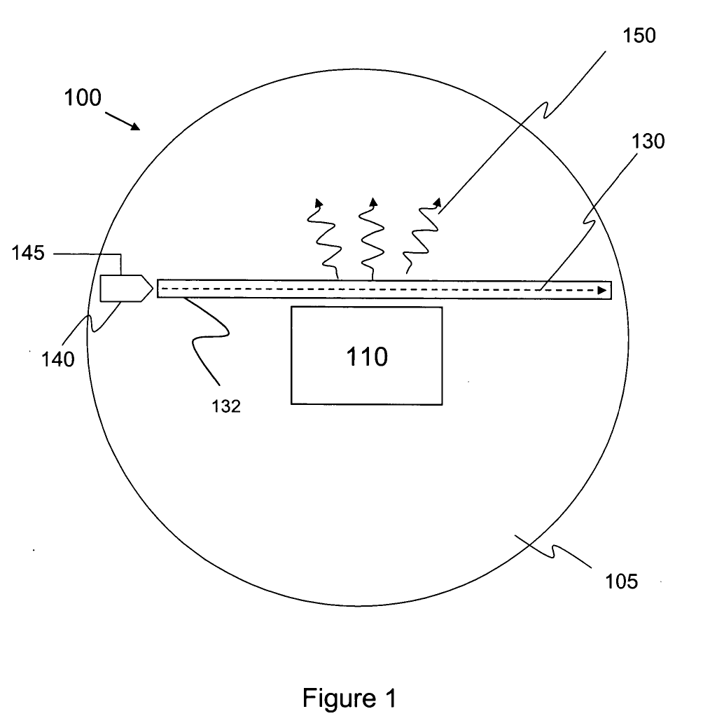

Turning to FIG. 1, a wavelength element 100 on a substrate 105 (such as a semiconductor substrate or a circuit board) can be produced from at least one resonant structure 110 that emits light (such as infrared light, visible light or ultraviolet light or any other electromagnetic radiation (EMR) 150 at a wide range of frequencies, and often at a frequency higher than that of microwave). The EMR 150 is emitted when the resonant structure 110 is exposed to a beam 130 of charged particles ejected from or emitted by a source of charged particles 140. The source 140 is controlled by applying a signal on data input 145. The source 140 can be any desired source of charged particles such as an electron gun, a cathode, an ion source, an electron source from a scanning electron microscope, etc.

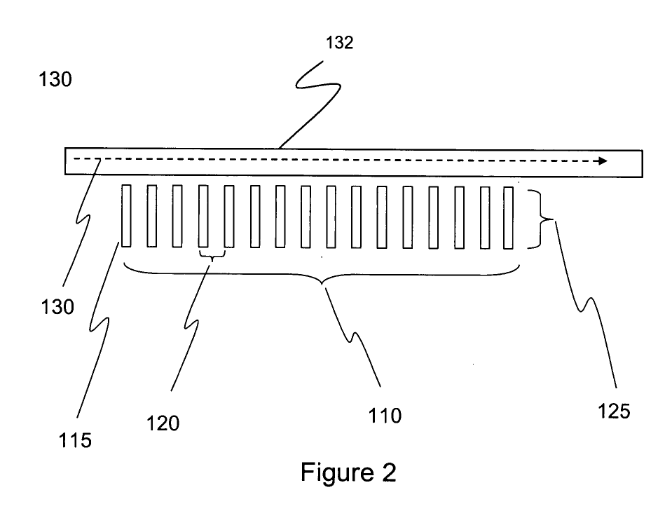

Exemplary resonant structures are illustrated in FIG. 2 where a resonant structure 110 may comprise a series of fingers or posts 115 which are separated by a spacing 120 measured as the beginning of one finger 115 to the beginning of an adjacent finger or post 115. The finger 115 has a thickness that takes up a portion of the spacing between fingers 115. The fingers also have a length 125 and a height (not shown). As illustrated, the fingers or posts of FIG. 2 are perpendicular to the beam 130. Further details of the formation and design of such fingers or posts, as well as the design and sizing of these ultra-small resonant structures, can be found in the above referenced applications, which have been incorporated herein by reference thereto, and further description herein is not necessary for a complete understanding of the present devices.

Resonant structures 110 are fabricated from resonating material (e.g., from a conductor such as metal (e.g., silver, gold, aluminum and platinum or from an alloy) or from any other material that resonates in the presence of a charged particle beam). Other exemplary resonating materials include carbon nanotubes and high temperature superconductors.

When creating any of the wavelength elements 100, the various resonant structures can be constructed in multiple layers of resonating materials but are preferably constructed in a single layer of resonating material (as described above).

In one single layer embodiment, all the resonant structures 110 of a resonant element 100 are etched or otherwise shaped in the same processing step. In one multi-layer embodiment, the resonant structures 110 of each resonant frequency are etched or otherwise shaped in the same processing step. In yet another multi-layer embodiment, all resonant structures having segments of the same height are etched or otherwise shaped in the same processing step. In yet another embodiment, all of the resonant elements 100 on a substrate 105 are etched or otherwise shaped in the same processing step.

The material need not be a contiguous layer, but can be a series of resonant elements individually present on a substrate. The materials making up the resonant elements can be produced by a variety of methods, such as pulsed-plating, depositing, sputtering or etching. Preferred methods for doing so are described in co-pending U.S. application Ser. No. 10/917,511, filed on Aug. 13, 2004, entitled “Patterning Thin Metal Film by Dry Reactive Ion Etching,” and in U.S. application Ser. No. 11/203,407, filed on Aug. 15, 2005, entitled “Method Of Patterning Ultra-Small Structures,” both of which are commonly owned at the time of filing, and the entire contents of each of which are incorporated herein by reference.

At least in the case of silver, etching does not need to remove the material between segments or posts all the way down to the substrate level, nor does the plating have to place the posts directly on the substrate. Silver posts can be on a silver layer on top of the substrate. In fact, we discovered that, due to various coupling effects, better results are obtained when the silver posts are set on a silver layer, which itself is on the substrate.

Reference can be made to the above referenced application Ser. No. 11/325,571 where a number of alternative post and/or finger designs and arrangements are set forth and described in detail, including ultra-small resonate structures which are designed to emit visible light, including in the red, blue and green spectrums, as well as multi-color emissions, all of which can be shielded as disclosed herein.

As shown in FIG. 1, the beam of charged particles 130 is traveling in a straight line adjacent the resonant structure 110. Consequently, the path along which grounded shielding 132 can be formed or created can encompasses an area slightly wider that the beam's width and as long as the beams path across the substrate 105. Shielding 132 is preferably formed of a layer of conductive material, such as silver or other conductive material, including conductive polymers, having a thickness of about 10 nm or greater. In addition, shielding 132 can be deposited or formed on substrate 105, for example, in an electroplating process. Alternatively, where a conductive layer, for example, had been deposited on the entire substrate surface during the formation of the posts or fingers 115, a desired shielding portion of that conductive layer could be left in place, as determined by suitable patterning, and thus not removed. The shielding 132 can be grounded by any convenient means known to those skilled in the art.

A similar shielding area 132 has been created in FIG. 2 where the resonant structure is in the form of a plurality of fingers or posts 115. Here again, because the path of beam 130 is along a straight line the shielding 132 can be in the form of an elongated rectangular area slightly wider than the beam and with a length at least equal to the length of the beam 130 as it travels across substrate on which the fingers or posts 115 are formed.

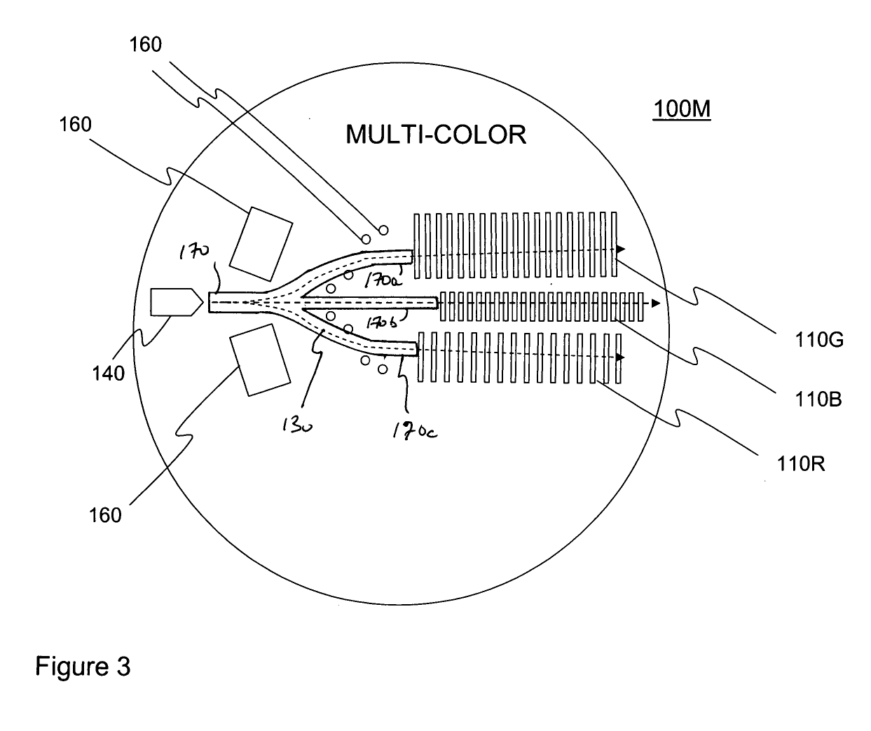

In the embodiment illustrated in FIG. 3, a plurality of wavelengths can be produced from a single beam by using a series of beam deflectors 160 at various points along the path of beam 130 which is shown as being deflected across the surface of substrate 105 and variously between resonant structures 110R, 110B and 110G. In this instance, the path along which beam 130 passes is much greater than in either of the FIG. 1 or 2 embodiments, resulting in both an extended path of travel so that an equally extended area of shielding can be used to cover the possible paths along or across which beam 130 might be moved by the deflectors 160.

Where the beam is controlled by being pulsed, the area that can be shielded can be more limited as shown at 170, with three specific legs 170a, 170b and 170c adjacent the resonant structures 110G, 110B and 110R, respectively. This is because the beam will be directed along specific paths and the shielding can be deposited in an area that will reflect those specific paths as well. However, where the beam is to be controlled by analog signals, the beam may sweep between the resonant structures 110G toward resonant structures 110R during the course of its being deflected. In this case, the shielding could then cover a broader area and could be in the shape of a fan spanning the whole area between legs 170a to 170c in FIG. 3. Further, it should be understood that in other embodiments, as described in any of the above related applications, where the charged particle beam is moving across a variable area of the substrate, for example where the beam is being curved or deflected in increments along the length of one or more sets of resonant structures, such beam movement would thereby be creating either or both an enlarging or reducing area. In such instances, the shielding could be deposited or formed on that portion of the substrate which would encompass the expected extremes of beam movement, including specifically the entire area across which the beam might be expected to travel.

The structure of FIG. 3 also shows several types of beam movement across the surface of a substrate. One portion, between the source 140 and the resonant structures 110R, 110B and 110G, shows a beam 130 that travels adjacent the surface of substrate, and this is the area where shielding 170 has been formed, including the legs 170a-170c. Additionally, the structure of FIG. 3 also demonstrates that the beam 130 can pass over, rather than next to (as shown in FIGS. 1 and 2), the resonant structures 110R, 110G and 110B. Whether shielding is needed in the area where beam 130 passes over the resonant structures depends upon a number of factors including the strength of the beam, the height of the resonant structures and thus how far the beam is raised away from the surface of the substrate, and the size of and the spacing between fingers or posts 115. Indeed, no shielding may be useful or even desirable in the area of the resonant structures, especially where any conductive material between fingers or posts 115 has not been fully removed during the formation process in which case the material will act as the shield. Where the resonant structures have no conductive material there between, and are extremely short, shielding might be useful and desirable.

It should also be understood that electron beams can be used in conjunction with receivers, and this same shielding will be useful in those applications as well. Reference can be directed to U.S. application Ser. No. 11/400,280 which is incorporated in its entirety by reference.

Additional details about the manufacturing and use of such resonant structures are provided in the above-referenced co-pending applications, the contents of which are incorporated herein by reference.

While certain configurations of structures have been illustrated for the purposes of presenting the basic structures of the present invention, one of ordinary skill in the art will appreciate that other variations are possible which would still fall within the scope of the appended claims. While the invention has been described in connection with what is presently considered to be the most practical and preferred embodiment, it is to be understood that the invention is not to be limited to the disclosed embodiment, but on the contrary, is intended to cover various modifications and equivalent arrangements as may be and are included within the spirit and scope of the appended claims.

We claim:

1. An ultra-small resonant device, comprising:
a charged particle generator configured to generate a beam of charged particles;
at least one resonant structure configured to resonate at least one resonant frequency higher than a microwave frequency, and
a layer of shielding extending at least along the path of the charged particle beam.

2. The device according to claim 1, wherein the shielding comprises a layer of conductive material extending along the path of travel of the beam and between the beam and a substrate on which the emitter is formed.

3. The device according to claim 1, wherein the conductive material is silver.

4. The device according to claim 1, wherein the generator comprises a plurality of charged particle sources and shielding is provided along a path of travel of each charged particle beam being produced.

5. The device according to claim 1, wherein the at least one resonant structure comprises at least one silver-based structure.

6. The device according to claim 1, wherein the at least one resonant structure comprises at least one etched-silver-based structure.

7. The device according to claim 1, wherein the beam of charged particles passes next to the at least one resonant structure and shielding is formed along a path that is wider than and at least as long as the beam of charged particles.

8. The device according to claim 1, wherein the beam of charged particles passes above the at least one resonant structure and the shielding extends at least between the charged particle generator and the at least one resonant structure.

9. The device according to claim 1, wherein the path along which shielding is provided at least equals the path across which the beam of charged particles may be deflected.

10. The device according to claim 1, wherein the shielding is grounded.

11. The device according to claim 1, further including:
a substrate;
an integrated circuit formed on the substrate; and
wherein the resonant structure is configured above the integrated circuit and the layer of shielding is configured between the resonant structure and the integrated circuit.
